(19) United States
(12) Patent Application Publication
(10) Pub. No.: US 2026/0238699 A1
(43) Pub. Date: Aug. 13, 2026

(54) METHOD OF SELECTING A USER PROFILE OF AN APPLICATION FOR OPENING A URL

(71) Applicant: 11point2 Pty Ltd, Adelaide (AU)

(72) Inventors: George FRENEY, Fullarton (AU); Rajat KULSHRESTHA, Wahroonga (AU); Nikhil SINGH, Wahroonga (AU); Mark OGDEN, Dulwich (AU); Ashleigh GREAVES, Hove (AU)

(21) Appl. No.: 19/155,076

(22) PCT Filed: Feb. 9, 2024
(86) PCT No.: PCT/AU2024/050084

§ 371 Date: Aug. 8, 2025

(30) Foreign Application Priority Data
Feb. 10, 2023 (AU) 2023900326

(51) Int. Cl. H04L 67/306; G06F 16/955; G06N 20/00; G06V 10/40

(52) U.S. Cl. CPC H04L 67/306; G06F 16/9566; G06N 20/00; G06V 10/40

(57) ABSTRACT

The present invention relates to a computer-implemented method of selecting a user profile of an application by a control application implemented on a user device for opening a URL and opening, by the application, the URL using the selected user profile of the application.

### TECHNICAL FIELD

The present invention relates to a computer-implemented method of selecting a user profile of an application implemented on a user device for opening a URL.

### BACKGROUND OF INVENTION

The Internet is typically used by a user of a user computing device (i.e., user device) for both business and personal use. Often, however, the user may wish to segregate their business and commercial use. Further, a user may work across multiple organisations and wish to segregate their use of the Internet according to the organisation.

For example, a user of a user device may use the same web browser to browse webpages for both business and personal use and, to try and segregate this use into work and business, the user may set up multiple web browser profiles. Typically, however, whenever the user clicks a link to a URL external to a web browser (e.g. a desktop application), the URL will open in the last used web browser profile. This may not be the desired browser profile so the user would then be required to take manual, time-consuming action to open the URL in the desired browser profile. That is, the user may be required to manually open the desired browser profile tab, copy the URL from the incorrect browser profile tab address bar, and paste the URL into the desired browser profile tab. This cumulatively adds up to a significant amount of wasted user time.

In addition, each profile of the web browser may have different authorisation and settings so some URLs will not have access to be opened on some web browser profiles. Some of these settings are also managed by a third party on remote servers. Some information is not readily able or desired to be processed remotely from the user device too. These problems with remote processing will also cumulatively add up to a significant amount of wasted resource time.

A reference herein to a patent document or other matter which is given as prior art is not to be taken as an admission that that document or matter was known or that the information it contains was part of the common general knowledge in Australia or elsewhere as at the priority date of any of the disclosure or claims herein. Such discussion of prior art in this specification is comprised to explain the context of the present invention in terms of the inventor's knowledge and experience.

### SUMMARY OF INVENTION

According to one aspect of the present invention, there is provided a computer-implemented method of selecting a user profile of an application implemented on a user device for opening a URL, comprising: implementing a control application by at least one processor in association with at least one memory on a user device; receiving, by the control application, user profile data relating to user profiles of an application implemented on the user device; receiving, by the control application, a URL for a resource from a further application implemented on the user device in response to user input to a user interface of the further application by a user of the user device; capturing, by the control application, a screenshot image of at least the user interface of the further application upon receipt of the URL; extracting, by the control application, features from the screenshot image associated with the URL; building, by the control application, a machine learning based model to predict user profiles of the application corresponding to the URL using the features as training data for the model and the user profile data; selecting, by the control application, one of the user profiles of the application implemented on the user device for opening the URL based on the model; outputting, by the control application, the selected user profile to the application; and opening, by the application, the URL using the selected user profile of the application.

The application may be a web browser and the user profiles are web browser user profiles, such as a work profile and a personal profile. That is, in an embodiment, the user profile data comprises categories of each of the user profiles of the application. As mentioned above, the user profiles may be for multiple different work profiles. The categories may therefore be work A, work B, home, etc.

In an example, the resource identified by the URL may be a web page but this resource could also be a communications platform meeting request, such as a Teams or Zoom meeting request, or an email. That is, the URL could be a mail to link, Zoom link, Slack link, Teams link, etc.

The user device is typically a computing device which comprises the at least one processor and the at least one memory, as well as a display and input devices. The user device executes software to provide a user interface for the user to interact with the user device via the input devices. The user device implements at least the application, e.g., web browser, the control application, and the further application. It will be appreciated by those persons skilled in the art that these applications implemented by the user device have user interfaces for the user to interact with the applications.

In an example, the URL is for a web page received by the control application from a further application such as Slack. The control application runs on the user device only to select the desired user profile for opening the web page based on the machine learning model. There are multiple technical advantages to having the control application be implemented locally on the user device. Firstly, by implementing the control application locally, the user's privacy is maintained, as user data does not leave the user device. That is, the user's personal and private information is not transmitted from the user device. Also, the speed and performance of the control application is improved.

In an example, the control application then outputs the user profile to the web browser and the web browser opens the web page using the selected user profile. The control application is performed separately from the web browser. The control application thus implements the machine learning models, rather than the web browser. Also, generally, browser extensions do not have the ability to do so. Other advantages include the control application being able to manage cross browser preferences, which is also not possible with browser extensions. By design, web browser profiles compartmentalise all aspects of the operation of the web browser. This means that the web browser cannot switch between profiles from within the web browser. The control application is thus separate to the web browser so that different user profiles in the web browser can be selected.

In an embodiment, the features are indicative of details of the further application. The features may further comprise details of a sender of the URL from the further application, a receiver of the URL from the further application, and details of the further application.

In an embodiment, the features comprise text features and the method further comprises extracting the text features from the screenshot image using an Optical Character Recognition (OCR) engine.

That is, in an example, the control application captures a screenshot image of the user interface of the further application, e.g., Slack, upon receipt of a click of the URL within Slack. The control application, using the OCR engine, extracts text features such as details of the Slack application itself as well as the sender and recipient of the URL within the Slack application.

In an embodiment, the machine learning model comprises a classification model for classifying the text features into the categories of each of the user profiles of the application.

In an embodiment, the features comprise visual element features. In this embodiment, the machine learning model comprises a feature extraction model for extracting the visual element features from the screenshot image associated with the URL. Further, the machine learning model comprises a classification model for classifying the visual element features into the categories of each of the user profiles of the application.

In an embodiment, the method further comprises the user initially training the machine learning based model, using the control application, by selecting user profiles of the application corresponding to the URL in a user interface of the control application. The user then further initially trains the machine learning model by having the control application suggest a predicted user profile of the application corresponding to the URL and the user selecting the predicted user profile of the application in the user interface of the control application.

In an embodiment, the method further comprises initially training the feature extraction model and the classification model using screenshot images comprising visual element features corresponding to URLs general to all users. For example, initially training the feature extraction model and the classification model is performed by selecting and annotating example screenshot images.

In an embodiment, the method further comprises further training the feature extraction model with the features extracted by from the screenshot image.

In an embodiment, the method further comprises the user further training the feature extraction model by the control application suggesting a predicted user profile of the application corresponding to the URL and the user selecting the predicted user profile of the application in the user interface of the control application.

In an embodiment, the method further comprises receiving, by the control application, meta data associated with the URL and using the metadata as further training data for the model. The meta data may comprise details of the application, such as the last opened user browser profile. Examples of further meta data include application names, people names, and any content in the screenshot.

In an embodiment, the user profile data comprises rules defined by the user for the control application selecting the user profiles of the application for opening the URL. For example, one rule may be that a particular web page is always opened in a designated user profile.

In an embodiment, the method further comprises saving the user profile data and the extracted features on the at least one memory. In addition, or in the alternative, the method further comprises saving the screenshot image on the at least one memory. The method may then further comprise saving the screenshot image on the at least one memory for a designated time and then deleting the screenshot image beyond this designated time. This ensures that the control application does not store massive amount of data on the user device which can cause disk space issues. Once the screenshot has been used and processed via the OCR engine, the control application can discard the screenshot to manage disk space and to keep the overall user device performing optimally.

Another aspect of the present invention comprises software for use with a user device comprising a processor and memory for storing the software, the software comprising a series of instructions executable by the processor to carry out the method as claimed in any one of the preceding claims.

Another aspect of the present invention comprises a computer readable media comprising the above software.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1 is a schematic of a user device for selecting a user profile of an application implemented on the user device for opening a URL according to an embodiment of the present invention;

FIG. 2 is a flow chart showing applications implemented on a user device of FIG. 1;

FIG. 3 is a further flow chart showing applications implemented on a user device of FIG. 1;

FIG. 4 is a flow chart showing the control engine of FIG. 3 in more detail; and

FIG. 5 is a flow chart summarising a method of selecting a user profile of an application implemented on a user device for opening a URL according to an embodiment of the present invention.

### DETAILED DESCRIPTION

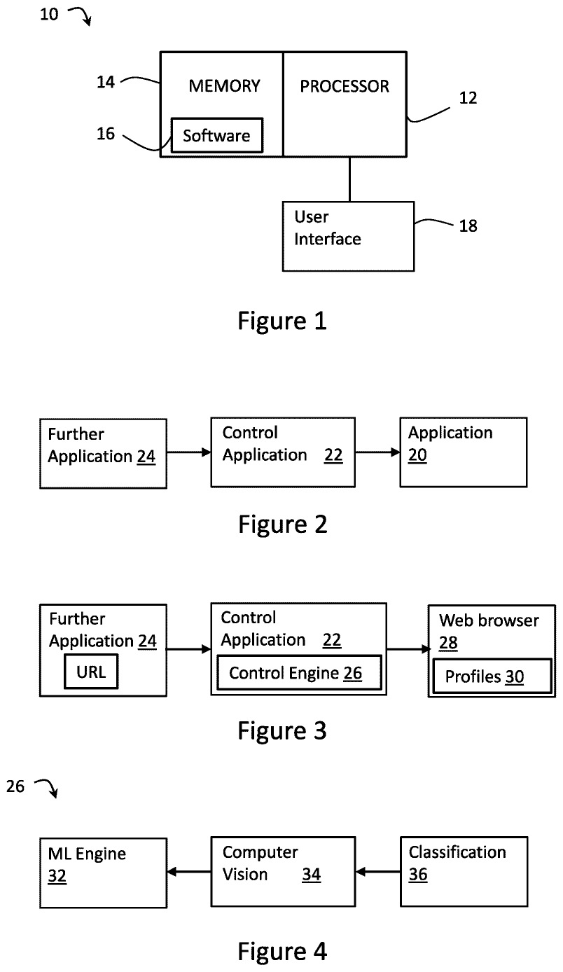

A user device 10 for selecting a user profile of an application implemented on the user device for opening a URL according to an embodiment of the present invention is shown in FIG. 1. The user device 10 comprises a processor 12 and a memory 14. The memory 14 contains software 16, resident thereon, comprising a series of instructions executable by the processor 12 to configure the processor 12 to perform steps to select a user profile of an application for opening a URL.

As mentioned above, in an embodiment, the application implemented on the user device is a web browser, the URL is for a resource, which is generally a web page, and the user profiles comprise at least a home user profile and a work user profile. The user device 10 implements the application 20, hereinafter referred to as web browser 28, a control application 22 and a further application 24, as shown in FIGS. 2 and 3. The processor 12 of the user device 10 implements these applications in association with at least software 16 resident on the memory 14 on the user device 10.

Also, the user device 10 has a display and input devices (not shown), and implements a user interface 18 associated with one of more of these applications as would be understood by a person skilled in the art.

A user of the user device 10 wishing to deploy the control application 22 first installs it on the device 10 and registers it as the default web browser of the device 10. The control application 22 then receives user profile data relating to user profiles of the web browser 28 that is implemented on the user device 10 from the user. The user profile data comprises categories of each of the user profiles of the application, such as home and various workspaces. The user of the control application 22 inputs this user data into the user interface 18 via user input devices and the user profile data is saved in the memory 14 of the user device 10.

The user interface 18 is the component of the control application 22 that is visible to the user and allows the user to understand the status and operate of the control application 22, to train the control application 22, and to help adapt the control application 22 to suit their usage.

The control application 22 is registered as the default web browser of the user device 10 so that it be advised of the user clicking a URL. When the control application 22 receives a URL for a resource, e.g., a web page, from a user input to the user interface 18 of the further application 24, e.g., Slack, that is also implemented on the user device 10, the control application 22 performs a number of steps to select the desired user profile for the web browser 28 to open that URL.

To do so, the control application 22 firstly builds machine learning based models to predict user profiles of the web browser 28 corresponding to URLs. As an example, the models comprise a feature extraction model and a classification model. These models are initially trained using screenshot images comprising visual element features corresponding to URLs general to all users. Further, the classification model may also be initially trained by the user selecting user profiles of the web browser 28 corresponding to URLs in the user interface 18. After sufficient training is performed, the control application 22 may further train the machine learning model by suggesting a predicted user profile of the web browser 28 corresponding to URLs in the user interface 18 and having the user select the predicted user profile of the web browser 28 in the user interface 18.

The initially trained models can then be deployed by the control application 22 to automate the selection of user profiles of the web browser 28. The control application 22 then builds the machine learning based models to automatically predict user profiles of the web browser 28 corresponding to a URL using features extracted from a captured screenshot image of at least the user interface 18 of the further application 204 upon receipt of a URL.

That is, upon receipt of a URL by the control application 22 clicked by a user in a further application 24, the control application 22 captures a screenshot image of at least the user interface 18 of the further application 24. In an example, the further application 24 is Slack and the screenshot image is a screenshot of the user using Slack at the time the URL is clicked upon. From the screenshot image, the control application 22 extracts features associated with the URL, using the pre-trained feature extraction model, and uses these features as training data for the classification model along with the user profile data.

The control application 22 then automatically selects one of the user profiles of the web browser 28 implemented on the user device 10 for opening the URL based on the results of the model and outputs the selected user profile 30 to the web browser 28. The web browser 28 then opens the URL using the selected user profile 30.

More specifically, the control application 22 implements a control engine 26 to build the above machine learning based model, which is shown in more detail in FIG. 4. The control engine 26 comprises a classification component 36, a computer vision component 34 and a machine learning engine 32.

The machine learning engine 32 has a small footprint, and fast training and fast inference properties. As a user will typically click on many URLs over a day, training will typically happen quite often. As mentioned, the machine learning engine 32 may be initially trained using screenshot images comprising visual element features corresponding to URLs general to all users. This is performed offline to enhance the performance of the engine 32.

The control application 22 extracts features from the screenshot image associated with the URL using computer vision 34 for classification 36. The URL has only limited information and has no other signals associated with it, so the screenshot provides the model with features that give the required signals to be able to select a desired user profile. The machine learning engine 32 can thus understand where the URL came from, who shared it with the user and from which application it was received from.

The control engine 26 extracts text features from the screenshot image associated with the URL using a computer vision component 34 in the form of an Optical Character Recognition (OCR) engine. These text features are indicative of details of the further application, such as details of the sender/receiver of the URL within the further application, and details of the further application itself, e.g., Slack.

The control engine 26 employs a Support Vector Machine (SVM) for classifying the text features into the categories, e.g., work and home, of each of the user profiles of the web browser 28. The classified text features can thus be used by the control engine 26 to predict the user profiles. In addition, the control application 22 may receive meta data associated with the URL, such as details of the last open user profile in the web browser, and uses this metadata as further training data for the model.

An example of a feature vector of the machine learning based model is provided in the table below.

| | | | | Profile |
|---|---|---|---|---|
| URL | App | App_details_1 | App_details_2 | (Label) |
| www.apple.com | Outlook | — | — | Work |
| www.clickup.com | Slack | Sender | Receiver | Home |

As an alternative to using Support Vector Machines for classification techniques, other machine learning classification models can be used for classification. In the Support Vector Machines embodiment, there are multiple parts to the overall classification: to identify the App given a screenshot; to identify features from the screenshot; extracting signals from the screenshot; and then using the vector, which has the tuple like <URL, signals>, to map to a profile.

In the embodiment, pre analysis of the images is conducted by the machine learning engine 32 to allow the images to be perfectly used by the model. As an example, a UI hierarchy is constructed from features detected on the screenshot, supporting the detection of the location and type of UI elements, and classification of semantic groups. This information is then used to determine the app and actual features which are important as signals.

Once the feature vector is ready, the vector is passed through another SVM based classification model which tries to map the vector to the right browser profile. Given the number of signals, a deep neural network to perform the mapping.

In an embodiment, Optical Character Recognition (OCR) is performed by deep learning algorithms, particularly Convolutional Neural Networks (CNNs) and Recurrent Neural Networks (RNNs). These algorithms have achieved impressive results in extracting features, such as in text recognition from images and videos, handwriting recognition, and scene text recognition. The embodiment uses CNN for OCR and to extract keywords from the screenshot.

As mentioned, the user interface 18 of the control application 22 can be used for the user to input user profile data. It can also be used to show historic learning to the user for user feedback to improve the model. In addition, the user can input rules as further user profile data that are defined by the user for the control application 22 to select user profiles for opening certain URLs. For example, Twitter URLs are always opened in a particular user profile irrespective of the further application 24 in which they are opened and who sent it to the user.

These rules are stored in the memory 14. The memory 14 stores all data locally on the user device 10, whether used for training the model, for a rules engine or for showing history the training on the user interface 18. The amount of data to be stored must thus be regulated as it impacts upon the storage available for the operation of the user device 10. After the model is initially trained, the control application may thus only store data, comprising at least the screenshot images, on the memory 14 for a designated time and then deletes this data beyond the designated time. For example, the designated time is 1 to 3 days. Data privacy and security is thus also provided by processing the data locally and not sending any data to the cloud for training or learning purposes. Also, the machine learning model is trained and implemented on the user device 10 locally as described above.

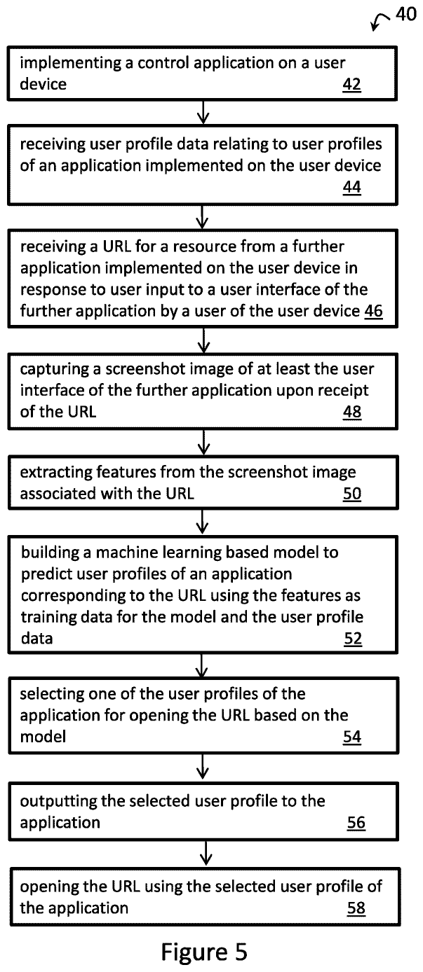

An embodiment of a computer-implemented method 40 of selecting a user profile of an application implemented on a user device for opening a URL is shown in FIG. 5. The method 40 comprises: implementing 42 a control application by at least one processor in association with at least one memory on a user device; receiving 44, by the control application, user profile data relating to user profiles of an application implemented on the user device; receiving 46, by the control application, a URL for a resource from a further application implemented on the user device in response to user input to a user interface of the further application by a user of the user device; capturing 48, by the control application, a screenshot image of at least the user interface of the further application upon receipt of the URL; extracting 50, by the control application, features from the screenshot image associated with the URL; building 52, by the control application, a machine learning based model to predict user profiles of the application corresponding to the URL using the features as training data for the model and the user profile data; selecting 54, by the control application, one of the user profiles of the application implemented on the user device for opening the URL based on the model; outputting 56, by the control application, the selected user profile to the application; and opening 58, by the application, the URL using the selected user profile of the application.

In addition, it will be appreciated by those persons skilled in the art that further aspects of the method 40 will be apparent from the above description of the user device 10. Further, persons skilled in the art will also appreciate that at least part of the method 40 could be embodied in software (e.g., program code) that is implemented by the processor 12 configured to control the user device 10 for selecting a user profile of an application implemented on the user device for opening a URL.

The software 16 could be supplied in a number of ways, for example of a tangible computer readable medium, such as a disc, or in the memory 14 as shown in FIG. 1.

Those skilled in the art will also appreciate that the invention described herein is susceptible to variations and modifications other than those specifically described. It is to be understood that the invention comprises all such variations and modifications.

Where any or all of the terms “comprise”, “comprises”, “comprised” or “comprising” are used in this specification (comprising the claims) they are to be interpreted as specifying the presence of the stated features, integers, steps or components, but not precluding the presence of one or more other features, integers, steps or components.

1. A computer-implemented method of selecting a user profile of an application implemented on a user device for opening a URL, comprising:
implementing a control application by at least one processor in association with at least one memory on a user device;
receiving, by the control application, user profile data relating to user profiles of an application implemented on the user device;
receiving, by the control application, a URL for a resource from a further application implemented on the user device in response to user input to a user interface of the further application by a user of the user device;
capturing, by the control application, a screenshot image of at least the user interface of the further application upon receipt of the URL;
extracting, by the control application, features from the screenshot image associated with the URL;
building, by the control application, a machine learning based model to predict user profiles of the application corresponding to the URL using the features as training data for the model and the user profile data;
selecting, by the control application, one of the user profiles of the application implemented on the user device for opening the URL based on the model;
outputting, by the control application, the selected user profile to the application; and
opening, by the application, the URL using the selected user profile of the application.

2. The method of claim 1, wherein the user profile data comprises categories of each of the user profiles of the application.

3. The method of claim 1, wherein the features are indicative of details of the further application.

4. The method of claim 3, wherein the features comprise details of a sender of the URL from the further application, a receiver of the URL from the further application, and details of the further application.

5. The method of claim 1, wherein the features comprise text features and the method further comprises extracting the text features from the screenshot image using an Optical Character Recognition (OCR) engine.

6. The method of claim 5, wherein the machine learning model comprises a classification model for classifying the text features into categories of each of the user profiles of the application.

7. The method claim 1, wherein the features comprise visual element features.

8. The method of claim 7, wherein the machine learning model comprises a feature extraction model for extracting the visual element features from the screenshot image associated with the URL.

9. The method of claim 8, wherein the machine learning model comprises a classification model for classifying the visual element features into categories of each of the user profiles of the application.

10. The method of claim 9, further comprising initially training the feature extraction model and the classification model using screenshot images comprising visual element features corresponding to URLs general to all users.

11. The method of claim 10, further comprising further training the feature extraction model with the features extracted by from the screenshot image.

12. The method of claim 10, further comprising the user further training the feature extraction model by the control application suggesting a predicted user profile of the application corresponding to the URL and the user selecting the predicted user profile of the application in the user interface of the control application.

13. The method of claim 1, further comprising receiving, by the control application, meta data associated with the URL and using the meta data as further training data for the model.

14. The method of claim 13, wherein the meta data comprises details of the application.

15. The method of claim 14, wherein the application comprises a web browser, the user profiles are user browser profiles, and the details of the application comprise the last open user browser profile.

16. The method of claim 2, wherein the user profile data comprises rules defined by the user for the control application selecting the user profiles of the application for opening the URL.

17. The method of claim 1, further comprising saving the user profile data and the extracted features on the at least one memory.

18. The method of claim 17, further comprising saving the screenshot image on the at least one memory.

19. The method of claim 18, further comprising saving the screenshot image on the at least one memory for a designated time and then deleting the screenshot image beyond this designated time.

20. Software for use with a user device comprising a processor and memory for storing the software, the software comprising a series of instructions executable by the processor to carry out the method of claim 1.

21. A computer readable media comprising software as claimed in claim 20.
